(19) United States
(12) Patent Application Publication
(10) Pub. No.: US 2009/0201504 A1
(43) Pub. Date: Aug. 13, 2009

(54) Hydrodynamic focusing for analyzing rectangular microbeads

(75) Inventors: Winston Ho, Hacienda Heights, CA (US); John Collins, Irvine, CA (US); Peter Low, Glendale, CA (US)

Correspondence Address: LIU & LIU, 444 S. FLOWER STREET SUITE 1750, LOS ANGELES, CA, 90071, US

(73) Assignee: Maxwell Sensors, Inc.

(21) Appl. No.: 12/386,369

(22) Filed: Apr. 17, 2009

Related U.S. Application Data
(63) Continuation-in-part of application No. 12/069,720, filed on Feb. 11, 2008.
Application No. 12/069,720 is a continuation-in-part of application No. 11/580,514, filed on Oct. 13, 2006.
Application No. 11/580,514 is a continuation-in-part of application No. 60/964,108, filed on Aug. 8, 2007.
Application No. 11/580,514 is a continuation-in-part of application No. 11/502,606, filed on Aug. 9, 2006.
(60) Provisional application No. 61/124,472, filed on Apr. 17, 2008.
(60) Provisional application No. 60/706,896, filed on Aug. 9, 2005.

(51) Int. Cl. G01B 11/27; G01F 1/00

(52) U.S. Cl. 356/399; 73/861

(57) ABSTRACT

A microfluidic apparatus having a one-dimensional or two-dimensional hydrodynamic flow system to control stable and proper digitally coded bead orientation through the optical detection area of a bioanalysis system. The hydrodynamic system include one core flow, which carries the rectangular barcode beads, and sheath flows, on the sides of or about or around the outer periphery of the core flow, pull the core flow into a proper orientation. The sheath flows, at much higher flow speed but lower volume flow rate, can be pushed or pulled by vacuum, gravity, or pressure. By this method, the coded bead will align themselves in line and flow reliably, without wobbling or flipping, in the core flow channel through the detection zone. By adjusting the relative flow rate of core flow and sheath flows, the coded beads flow reliably in the flow system, thus it can be decoded and detected by an optical system accurately.

This application is a continuation-in-part application of: (a) U.S. patent application Ser. No. 12/069,720 filed Feb. 11, 2008, which is a continuation-in-part of U.S. patent application Ser. No. 11/580,514 filed Oct. 13, 2006 (which is in turn a continuation-in-part of U.S. patent application Ser. No. 11/502,606 filed Aug. 9, 2006), and which claims the benefit of the priority of U.S. Provisional Patent Application No. 60/706,896 filed Aug. 9, 2005; (b) U.S. Provisional Patent Application No. 60/964,108 filed Aug. 8, 2007; and (c) U.S. Provisional Patent Application No. 61/124,472 filed Apr. 17, 2008. These applications are fully incorporated by reference, as if fully set forth herein. All other publications and U.S. patent applications disclosed herein below are also incorporated by reference, as if fully set forth herein.

### BACKGROUND OF THE INVENTION

1. Field of the Invention

The invention relates to carry out multiplexed bioassay with hundreds or thousands of digital magnetic barcode microbeads for proteins, nucleotides, and molecular diagnostics. The digital magnetic microbead is rectangular, non-traditional spherical latex bead; therefore, a microfluidic system is developed to properly control the orientation of the rectangular, non-spherical, bead in the flow system for rapid and accurate digital decoding and optical analysis.

2. Description of Related Art

As current research in genomics and proteomics require multiplexed data, there is a need for technologies that can rapidly screen a large number of targets, such as nucleic acids and proteins, in a very small volume of samples or in a test tube for gene mutation, drug resistance, pharmacogenomic, and disease diagnostics. Micro barcode bead technology provides flexibility with the assembly of various types and amount of beads/probes in an analysis, and due to its small volume (in the range of picoliter), hundreds or thousands of beads can be incubated with a very small amount of sample. Existing micro bead approaches include the incorporation of spherical beads or particles with spectrally distinguishable fluorophore, fluorescent semiconductor quantum dots, and metallic rods with either bar coded color (absorption) stripes or black and white strips. The problems of these methods are (1) the barcode contrast is low, (2) the light collection efficiency based on reflection is poor, and (3) limited number of barcode due to broad fluorescence bands and their overlapped. Many laser light sources are often needed to excite different fluorescent labels. In addition, the validity of the coding signatures is another serious concern, since the incorporated coding elements in some cases may be photo bleached, or interfered spectrally with the analytical signals. In the case of multi-metal (Au, Pt, Ni, Ag, etc) color micro rods, the encoding scheme suffers from the difficulty of manufacturing and the number of colors, based on different metal materials, is limited.

U.S. Pat. No. 6,773,886 issued on Aug. 10, 2004, entire contents of which are incorporated herein by reference, discloses a form of bar coding comprising 30-300 nm diameters by 400-4000 nm multilayer multi metal rods. These rods are constructed by electrodeposition into an alumina mold; thereafter the alumina is removed leaving these small multilayer objects behind. The system can have up to 12 zones encoded, in up to 7 different metals, where the metals have different reflectivity and thus appear lighter or darker in an optical microscope depending on the metal type whereas assay readout is by fluorescence from the target, and the identity of the probe is from the light dark pattern of the barcodes.

U.S. Pat. No. 6,630,307 issued on Oct. 7, 2003, entire contents of which are incorporated herein by reference, discloses semiconductor nano-crystals acting as a barcode, wherein each semiconductor nanocrystal produces a distinct emissions spectrum. These characteristic emissions can be observed as colors, if in the visible region of the spectrum, or may be decoded to provide information about the particular wavelength at which the discrete transition is observed.

U.S. Pat. No. 6,734,420 issued on May 11, 2004, entire contents of which are incorporated herein by reference, discloses an identification system comprising a plurality of identifiable elements associated with labels, the labels including markers for generating wavelength/intensity spectra in response to excitation energy, and an analyzer for identifying the elements from the wavelength/intensity spectra of the associated labels.

U.S. Pat. No. 6,350,620 issued on Feb. 26, 2002, discloses a method of producing a micro carrier employing the shape, size, and color of the carrier as image bar codes for identification. The patent discloses an identification system comprising a bar code is formed on the substrate by photolithography, and then using nickel plates to hot compress the bar code onto the surface of bead to form a microcake-like particle. The bar code pattern can be classified by an imaging recognition system.

U.S. Pub. No. US2005/0003556 A1, entire contents of which are incorporated herein by reference, discloses an identification system using optical graphics, for example, bar codes or dot matrix bar codes and color signals based on color information signal for producing the affinity reaction probe beads. The color pattern is decoded in optical reflection mode.

U.S. Pub. No. US2005/0244955, entire contents of which are incorporated herein by reference, discloses a micro-pallet which includes a small flat surface designed for single adherent cells to plate, a cell plating region designed to protect the cells, and shaping designed to enable or improve flow-through operation. The micro-pallet is preferably patterned in a readily identifiable manner and sized to accommodate a single cell to which it is comparable in size.

The assignee of the present invention developed a digital magnetic bead or Light Transmitted Assay Bead (LITAB) that has a pallet like body, with generally rectangular cross-sections (hereinafter beads with rectangular cross sections are referred to as “rectangular bead”). (See, U.S. patent application Ser. No. 11/580,514, filed Oct. 13, 2006, and U.S. patent application Ser. No. 12/068,720, filed Feb. 11, 2008). The rectangular bead is digitally coded as represented by an image that provides for high contrast and high signal-to-noise optical detection to facilitate identification of the bead. The image is implemented by a physical structure having a pattern that is partially substantially transmissive (e.g., transparent, translucent, and/or pervious to light), and partially substantially opaque (e.g., reflective and/or absorptive to light) to light. The pattern of transmitted light is determined (e.g., by scanning or imaging), the code represented by the image on the coded bead can be decoded. In particular, the coded bead comprises a body having a series of alternating light transmissive and opaque sections, with relative positions, widths and spacing resembling a one-dimensional or two dimensional bar code image (e.g., a series of narrow slits (e.g., 5 microns in width) representing a “0” code and wide slits (e.g., 10 microns in width) representing a “1” code, or vice versa). The position of the slits on the pallet will determine which of the bits is the least significant (LSB) and most significant bit (MSB). The LSB will be placed closer to the edge of the pallet to distinguish it from the MSB at the other, longer end.

Rectangular beads have a planar body with a relatively thin thickness (e.g. a width×length×thickness of 100×300×20 μm). The orthogonal cross sections (e.g. 100×300 μm, 100×20 μm, and 20×300 μm) are different in relative geometries and/or sizes. The rectangular beads are digitally encoded (e.g., by a bar code pattern) in reference to the largest planar surface (i.e., the 300×100 μm surface) and optically decoded by directing an optical beam at the largest planar surface (e.g., by measuring light transmission to detect the bar code). Sample analysis (e.g., by fluorescence detection) is conducted by also directing an optical beam at the largest planar surface on which sample reactions take place. Accordingly, for rectangular bead analysis, the detected bead surface needs to be oriented orthogonal to an incident optical beam as shown in FIG. 1(d). Therefore, the whole detectable surface area of the bead should be illuminated uniformly with an optical beam. Both transmission and fluorescence intensity depend on the area of illumination and angle of illumination. It is especially critical for barcode identification and quantitative fluorescence measurement. If the bead is not aligned properly relative to the light beam, the transmission and fluorescence intensity will vary. Accordingly, compared to spherical particles, which by nature do not have geometrical orientation (i.e., spherical particles are symmetrical in all directions and orientations), the orientation of rectangular beads becomes important to effective optical analysis of such beads.

Heretofore, rectangular beads are analyzed in a static state (i.e., with the beads resting on a support). Such method of analysis is low throughput. It is desirable to provide a high speed, high throughput system for analyzing non-spherical encoded beads, with the foregoing design consideration in mind.

### SUMMARY OF THE INVENTION

The present invention is directed to a microfluidic system and method for decoding digitally encoded rectangular beads and/or optical analysis of such beads, with control of the orientation of the rectangular beads in the microfluidic system. No known flow system can control the position and orientation of the rectangular bead in the flow system.

In one aspect of the present invention, a microfluidic apparatus comprises a micro flow channel sized and configured to guide coded beads to advance one at a time pass an analysis zone (e.g., a decoding zone). The decoding zone includes a code detector (a light scanner, a CCD sensor, etc.) that detects the pattern of transmitted light through each coded bead for decoding the code represented by the image thereon. The flow channel of the microfluidic apparatus has an internal cross section that has a geometry that is sized and shaped to receive and allow the coded bead to pass through when a particular cross section of the coded bead is aligned with the cross section of the micro flow channel, thereby presenting the coded bead in a particular orientation with respect to the decoding zone. In one embodiment, the geometry of the internal cross section of the flow channel is sized and shaped to receive and allow the coded bead to pass through when the smallest cross section of the coded bead is aligned with the micro flow channel (e.g., the long axis of the coded bead is aligned with the axis of the flow channel). The microfluidic apparatus may include more than one micro flow channel, to provide decoding of coded beads in parallel channels.

In another aspect of the present invention, the microfluidic chip with microchannel is designed to have configuration which can guide the rectangular bead, a non-spherical bead, in high speed flow with bead stability and no clogging. The microfluidic flow system has a pressure controlled device which can deliver the hydrodynamic flow to provide a rectangular bead with correct orientation and position in the flow system for accurate optical decoding and fluorescence detection.

In another aspect of the present invention, a microfluidic apparatus comprises a one-dimensional or two-dimensional hydrodynamic flow system to control stable and proper bead orientation through the optical detection area. The hydrodynamic system include one core flow, which carries the rectangular barcode beads, and sheath flows, on the sides of or about or around the outer periphery of the core flow, pull the core flow into a proper dimension. The sheath flows, at a significantly higher volume flow rate compared to the core flow (e.g., about twice the volume flow rate of the core flow), but at a lower flow speed due to the significantly larger total cross sectional area of the sheath flows compared that of the core flow, can be pushed or pulled by vacuum, gravity, or pressure. By this method, the coded bead will align themselves in line and flow reliably, without wobbling or flipping, in the core flow channel through the detection zone. By adjusting the relative flow rate of core flow and sheath flows, the coded beads flow reliably in the flow system, thus it can be decoded and detected by an optical system accurately.

The rectangular bead is digitally coded as represented by an image that provides for high contrast and high signal-to-noise optical detection to facilitate identification of the bead. The image is implemented by a physical structure having a pattern that is partially substantially transmissive (e.g., transparent, translucent, and/or pervious to light), and partially substantially opaque (e.g., reflective and/or absorptive to light) to light. The pattern of transmitted light is determined (e.g., by scanning or imaging), the code represented by the image on the coded bead can be decoded.

In one embodiment, the digital magnetic microbeads comprise a first layer; a second layer; and an intermediate layer between the first layer and the second layer, the intermediate layer having an encoded pattern defined thereon, wherein the intermediate layer is partially substantially transmissive and partially substantially opaque to light, representing a code corresponding to each of the microbeads. Furthermore, the intermediate layer is based on paramagnetic material.

In one embodiment, the coded bead comprises a body having a series of alternating light transmissive and opaque sections, with relative positions, widths and spacing resembling a one-dimensional or two-dimensional bar code image (e.g., a series of narrow slits (e.g., 5 microns in width) representing a “0” code and wide slits (e.g., 10 microns in width) representing a “1” code, or vice versa). The position of the slits on the pallet will determine which of the bits is the least significant (LSB) and most significant bit (MSB). The LSB will be placed closer to the edge of the pallet to distinguish it from the MSB at the other, longer end.

### BRIEF DESCRIPTION OF THE DRAWINGS

For a fuller understanding of the scope and nature of the invention, as well as the preferred mode of use, reference should be made to the following detailed description read in conjunction with the accompanying drawings. In the following drawings, like reference numerals designate like or similar parts throughout the drawings.

FIG. 1(a) illustrates the prior art flow cytometer system for spherical bead analysis; FIG. 1(b) shows the cross-section view of a spherical bead in a cylindrical core flow surrounded by a sheath flow; FIG. 1(c) shows an optical beam illumination on a spherical bead, and FIG. 1(d) shows an optical beam illumination on a rectangular bead.

FIG. 2(a) is a top view of a LITAB in accordance with one embodiment of the present invention; FIG. 2(b) is a sectional view taken along line A-A in FIG. 2(a); FIG. 2(c) shows the transmitted digital signal of a barcoded bead representing 0011111001.

FIG. 3 illustrates the optical signal pulses representing light transmitted through the pattern of slits in a LITAB.

FIG. 4 illustrates the steps of forming a bead in accordance with one embodiment of the present invention.

FIG. 5 illustrates a metal layer as a layer sandwiched between two polymeric layers that may provide the same surface chemistry for molecule immobilization, in accordance with one embodiment of the present invention.

FIG. 6 schematically illustrates a microfluidic apparatus in accordance with one embodiment of the present invention.

FIG. 7 is a schematic diagram showing three types of geometrical orientation and motion of a rectangular bead, relative to the light beam, in a microfluidic channel.

FIG. 8 shows the top view of a microfluidic chip in accordance with one embodiment of the present invention.

FIG. 9 (a) illustrates the top plan view of a microfluidic apparatus that comprises a sheath flow system in accordance with one embodiment of the present invention; FIG. 9(b) shows the cross-sectional view of the rectangular channel with a core flow sandwiched between two sheath flows. The rectangular bead is confined in the center of the flow system.

FIG. 10 shows the relationship between the width of core flow and total flow rate (total flow rate being the sum of core flow rate and sheath flow rates).

FIG. 11(a) illustrates the top plan view and longitudinal sectional view of the microchannel with one-dimensional hydrodynamic focusing. FIG. 11(b) illustrates the schematic isometric view and sectional view of the microchannel with two-dimensional hydrodynamic focusing in accordance with one embodiment of the present invention. FIG. 11(c) shows the cross-sectional view of the rectangular channel with a rectangular core flow sandwiched between two sheath flows in each of two orthogonal coordinate axes.

FIG. 12 illustrates the process for preparing Light Transmitted Assay Beads (LITAB) for bioassay, in accordance with one embodiment of the present invention: (a) Multiple LITAB in a tube, (b) LITAB for bioassay, and (c) a photo image of LITABs.

FIG. 13 illustrates a bioanalysis system comprising a two-dimensional hydrodynamic focusing microfluidic apparatus in accordance with one embodiment of the present invention.

### DETAILED DESCRIPTION OF EMBODIMENTS OF THE INVENTION

For purposes of illustrating the principles of the present invention and not by limitation, the present invention is described herein below by reference to a micro bead that is in the shape of a pallet, and by reference to bioanalysis. However, it is understood that the present invention is equally applicable to micro beads of other overall geometries that are not symmetrical in all orientations, and which are applied for other applications requiring identification based on the identity of the beads, without departing from the scope and spirit of the present invention. To facilitate discussion below, the micro bead of the present invention is referred to as a LITAB, which stands for a light transmitted assay bead, as disclosed in assignee's earlier patent applications noted above.

Non-Spherical, Rectangular Barcode Beads

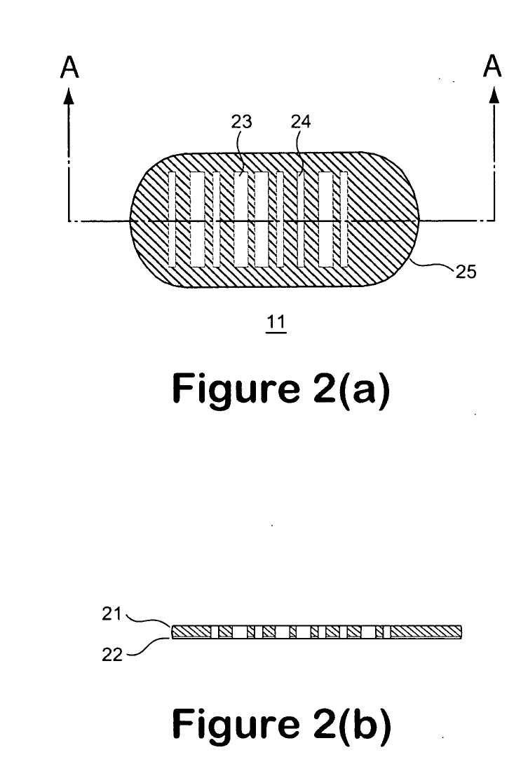

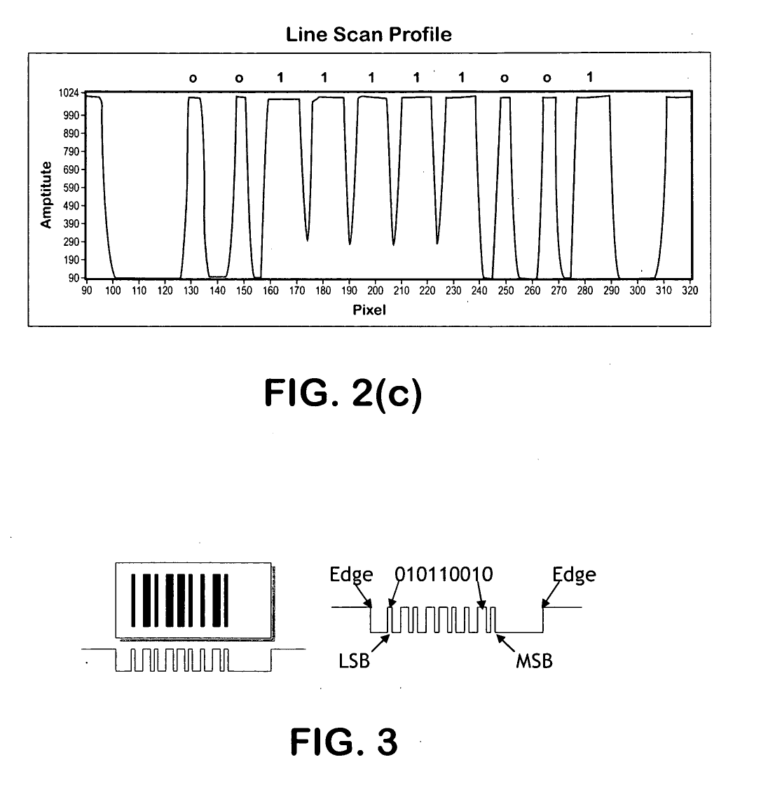

In one aspect of the present invention, a micro bead is digitally coded as represented by a two-dimensional image that provides for high contrast and high signal-to-noise optical detection to facilitate identification of the bead. The image on a two-dimensional planar surface is implemented by a physical structure having a pattern that is partially substantially transmissive (e.g., transparent, translucent, and/or pervious to light), and partially substantially opaque (e.g., reflective and/or absorptive to light) to light. The pattern of transmitted light is determined (e.g., by scanning or imaging), and the code represented by the image on the coded bead can be decoded. Various barcode patterns, such as circular, rectangular, or shape, can be designed as long as it represented a “1” or “0” and can be recognized by the decoder. The coded bead comprises a body having a series of alternating light transmissive and opaque sections, with relative positions, widths and/or spacing resembling a one-dimensional or two-dimensional bar code image (e.g., a series of narrow slits (e.g., about 1 to 5 microns in width) representing a “0” code and wide slits (e.g., about 1 to 10 microns in width) representing a “1” code, or vice versa, to form a binary code). FIG. 2 illustrates a coded bead, LITAB 11 in accordance with one embodiment of the present invention. The LITAB 11 has a body 25 in the shape of a flat pallet or disc. The body of the coded bead may be configured to have at least two orthogonal cross sections that are different in relative geometry and/or size. Further, the geometry of the cross sections may be symmetrical or non-symmetrical, and/or regular or irregular shape.

FIG. 2(a) shows that the planar geometry resembles a symmetrical stretched oval. FIG. 2(b) shows the cross section showing the longitudinal (or longest) axis. For a rectangular bead, the dimensions along at least two orthogonal axes are different. In the particular embodiment illustrated in FIGS. 2(a) and (b), all three orthogonal axes are of different lengths, and the geometries of all three orthogonal cross sections are symmetrical and of regular shape. For example, the bead 11 has a planar body with a width×length×thickness of 100×300×6 μm. The orthogonal cross sections (e.g. 100×300 μm, 100×6 μm, and 6×300 μm) are different in relative geometries and/or sizes. The rectangular beads 11 are digitally encoded (e.g., by a bar code pattern) in reference to the largest planar surface (i.e., the 300×100 μm surface) and optically decoded by directing an optical beam at the largest planar surface (e.g., by measuring light transmission to detect the bar code). Sample analysis (e.g., by fluorescence detection) is conducted by also directing an optical beam at the largest planar surface on which sample reactions take place.

A series of wide and narrow slits 23 and 24 are provided through the body 25, which may be made of or coated with a substantially light opaque material (e.g., reflective or absorptive). The wide and narrow slits 23 and 24 represent a logical “1” and “0”, respectively, or vice versa, and collectively represent a binary code (each slit representing a bit). In this embodiment, the code is analogous to a bar code. The narrow slits may have a width of 5 microns, and the wide slits 24 may have a width of 10 microns. For a LITAB having an overall dimension of 100×50×6 μm to 200 μm×100 μm×20 μm, at least about 10 slits may be provided on the disc to encode 10 bits to 12 bits or more, allowing 1,024 to 4,096 or more unique codes. In one embodiment, the longest orthogonal axis of the coded bead is less than 1 mm.

While the illustrated embodiment shows a pattern of slits of spaced apart narrow and wide width, it is also possible to use a pattern of slits having a constant width which are spaced apart at narrow and wide spacings between adjacent slits to represent 1's and 0's, without departing from the scope and spirit of the present invention. FIG. 2 (c) shows the high contrast transmission peaks of a single bead on a computer screen. When the bead is illuminated with a light beam, based on the either the “total intensity” of the transmission peak or the “bandwidth” of the transmission peak from the slit, the digital barcode either 0 or 1 can be determined by a line scan camera and a digital signal processor. Based on the figure, the barcode patterns can be easily identified based on the peak widths. The beads show 10-digit barcodes representing 0010110101.

For illustration purposes, FIG. 3 shows a series of signal pulses representing the detection of light transmitted through the slits 23 and 24 in the LITAB 11 in FIG. 2(a). The signal pulses correspond to the contrast of transmitted versus blocked light across the longitudinal axis of the LITAB 11. The width of each signal pulses represents a “1” or a “0” in the code of the LITAB 11. In the particular illustrated example, the wider pulses represent 1's and the narrow pulses represent 0's. The relative positions of the slits on the LITAB 11 determine which of the bits is the least significant bit (LSB) or the most significant bit (MSB). In one embodiment, the least significant bit was placed closer to one edge or end of the LITAB 11 to distinguish it from the most significant bit at the opposing edge or end. The concept of decoding the signal pulses is analogous to decoding for a traditional bar code.

The LITAB 11 may be fabricated using conventional methods used in thin film formation in a clean room microfabrication facility. The structure of the LITAB 11 may be obtained using processes that may include conventional photo-lithography, printing, silk-screening, curing, developing, etching (e.g., chemical etching, ion etching, and/or other removing processes), plating, dicing, and other process steps well known in the art for such types of structure and the material involved. For example, flexible circuits (also commonly known as “flex circuits”) have been used to a printed circuit board. Flex circuits usually consist of some sort of flexible polymer substrate having with one or more lines of conductive material leading from contact pads at one end of the flex circuit to a corresponding set of contact pads at the other. Conducting material can be replaced with paramagnetic materials for this application. The details of the steps in these processes have been omitted, as they may involve conventional patterning and photolithographic steps well known in semiconductor and/or micro-structure processing. The specific fabrication steps and materials involved, other than those specific steps and materials mentioned herein, when viewed alone are not a part of the present invention. It is noted that even though the disclosure herein may, by way of examples and not limitations, refer to specific coating, formation, patterning, deposition or other processes in connection with certain layers or structures, other processes may be substituted without departing from the scope and spirit of the present invention. There may be intermediate or interposing layers, coatings, or other structures present, and associated process steps present, which are not shown or discussed herein, but could be included without departing from the scope and spirit of the invention disclosed herein. For example, there may be buffer layers, primer layers, seed layers, adhesives, coatings, surface finishes, or other structures present. Other variations may be implemented without departing from the scope and spirit of the present invention.

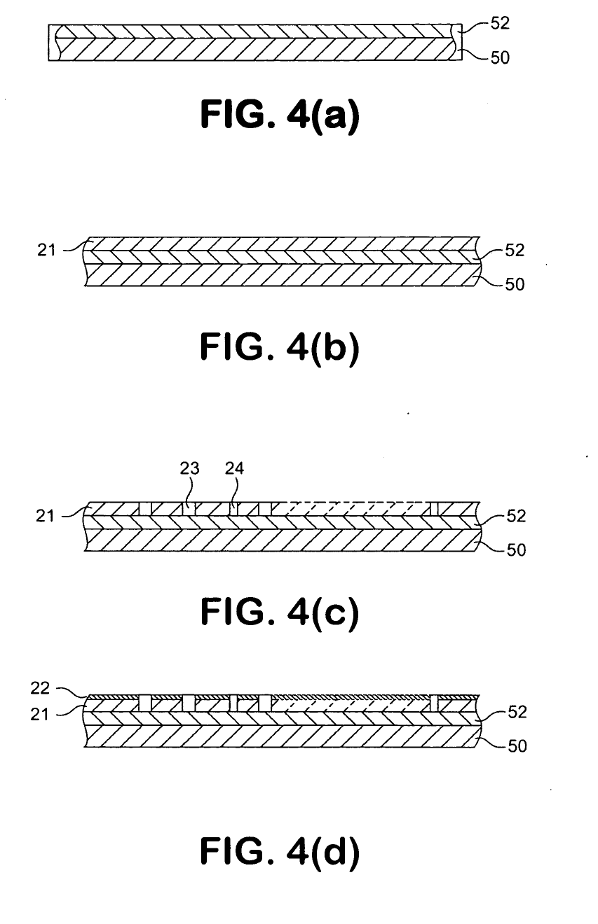

Referring to FIG. 4(a) to (d), in one embodiment of the process for fabricating the LITAB, a layer 52 of Ti (e.g., 100 nm) is deposited by e-beam evaporation on a substrate 50, e.g., a clean glass slide (e.g., about 1 mm thick). Ti functions as a conducting seed layer as well as a surrogate releasing layer. The LITAB material is configured to have about the same density as the liquid medium enabling the bead to suitably float in the medium. In addition, the material should be strong enough to be able to resist deformation that may result from sheer stresses during mixing and the like processes. The body 25 of the LITAB 11 may be formed using a layer of polymeric material. For example, a photoresist photopolymer (e.g., SU-8 and the like, as known in the art), may be utilized in creating the LITABs 11. A layer 21 of polymeric material is spin-coated on the Ti layer 52, and the slits 23 and 24 are formed in such layer using standard photolithographic procedures. For example, the slits 23 and 24 may be defined by UV-light irradiation using a photomask (not shown) defining the desired pattern of wide and narrow slits, and the planar shape of the LITAB body 25. An array of LITABs 11 may be formed on a single substrate, each having a different slit pattern representing a different code. The photomask may also define the periphery of the array of LITAB bodies, such that the LITAB bodies are separated from one another at the end of the same photolithographic process that defines the slits. Because SU-8 is transparent, an e-beam evaporator is utilized to deposit a metal layer, such as gold (Au, 0.1 μm) top layer 22 on the SU-8 layer 21 supported on the substrate 50. The individual LITAB bodies 25 are finally freed from the underlying substrate 50 by dissolving the surrogate Ti layer 52 with an etching solution containing hydrofluoric acid (HF). In this way, the gold pattern on the LITAB blocks light by reflecting light (directed to both from the side exposed and the side adjacent to the SU-8 layer 21), and slits not covered by gold layer transmit light. Because the gold layer 22 blocks the light, while the open slits transmit the light, LITAB “bar codes” provide high optical signal, and high optical contrast when the transmitted light is detected.

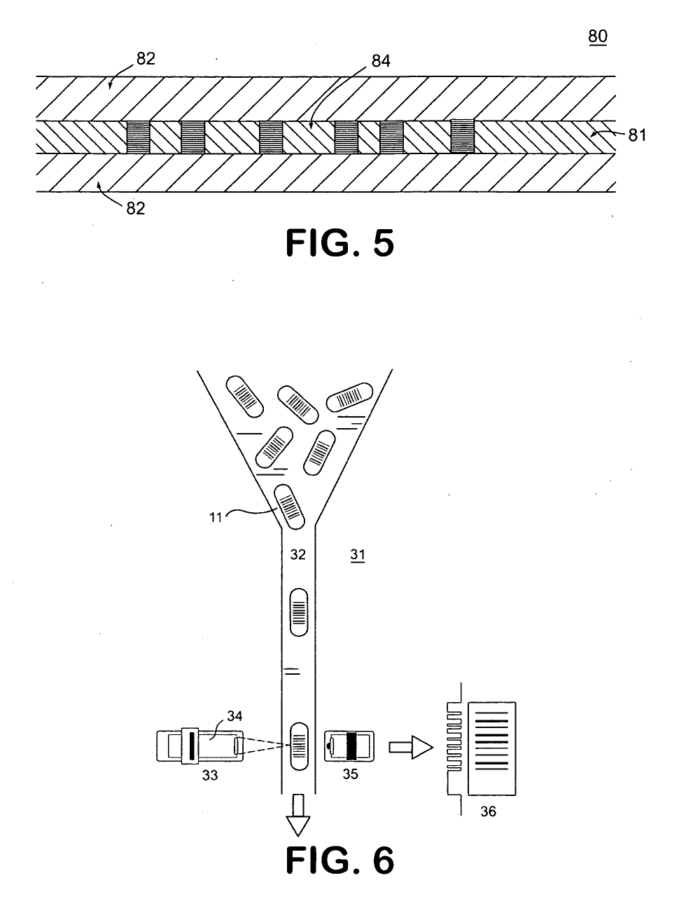

FIG. 5 shows an alternate embodiment of a LITAB 80, which may include a metal layer 81 as an intermediate layer sandwiched between two SU-8 layers 82. The two SU-8 layers are designated as the first layer and second layer in the claim. A barcode pattern is fabricated on the metal layer 81. For example, slits 84 of different widths and/or spacings are formed in the metal layer 81. In the illustrated embodiment, the SU-8 layers 82 are closed layers (i.e., no slits). The process for forming the LITAB 80 may include first forming a first SU-8 layer 82, then forming the metal layer 81 followed by etching the slits 84 therein. A second SU-8 layer 82 is formed on the metal layer 81 (e.g., by spin coating and curing), which fills the slits 84. Alternatively, the slits 84 may be first filled with another transparent material, before forming the second SU-8 layer 82. With this embodiment, surface condition could be made the same for both exposed planar surfaces of the LITAB, to provide similar surface coating and immobilization conditions. The other embodiment is to coat the LITAB with polymer or functional molecules, such as biotin, carboxylated, or streptavidin; therefore, the whole bead has the same condition for molecular immobilization.

To facilitate bioassays as will be apparent from further discussion below in connection with the microfluidic system, a paramagnetic material may be imbedded in the LITAB (e.g., as an intermediate layer 81 in FIG. 5), and sandwiched between the first layer and second layer of polymer films. LITABs are paramagnetic, that is, they have magnetic property when placed within a magnetic field, but retain no residual magnetism when removed from the magnetic field. Paramagnetic materials include magnesium, molybdenum, lithium, aluminum, nickel, and tantalum. Although paramagnetic materials are inherently dark brown, the LITAB rectangular bead has high contrast barcode pattern which can be easily identified. Therefore, the present invention would allow decoding based on transmitted light, even in the presence of the paramagnetic material. This allows magnetic collection of microbeads and resuspension of the beads when the magnetic field is removed. Collection and resuspension of the digital magnetic beads can be repeated easily and rapidly any number of times. Because of the easy operation, magnetic beads are used widely in high throughput automated operation. The common robotic automation is simply putting a 96-well, 384-well or 1536-well microplate on a magnetic stand and enables washing of unbound molecules from the beads, changing buffer solution, or removing any contaminant in the solution. For example, in the case of DNA or RNA assay, the unbound or non-specific nucleotides can be removed after hybridization. While in the case of protein assay, the unbound or non-specific antibodies or antigens can be removed after the antibody-antigen reaction. Extensive washing often required during molecular biology applications to be conducted swiftly, efficiently, and with minimal difficulty.

Flow System

Flow cytometer is a well-known technique for counting, examining, and sorting microscopic spherical particles suspended in a stream of fluid. It allows simultaneous multiparametric analysis of the physical and/or chemical characteristics of single cells or spherical beads flowing through an optical and/or electronic detection apparatus. Modern flow cytometers are able to analyze several thousand spherical particles every second, in “real time”, and can actively separate and isolate particles having specified properties.

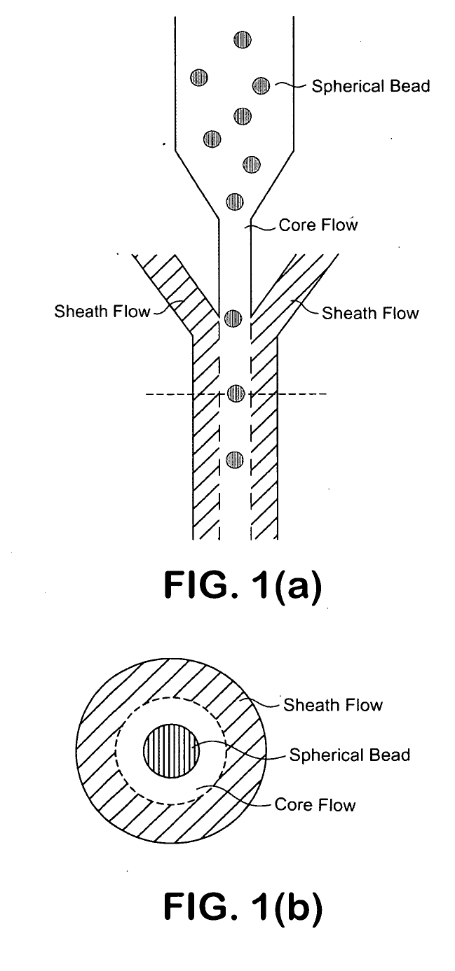

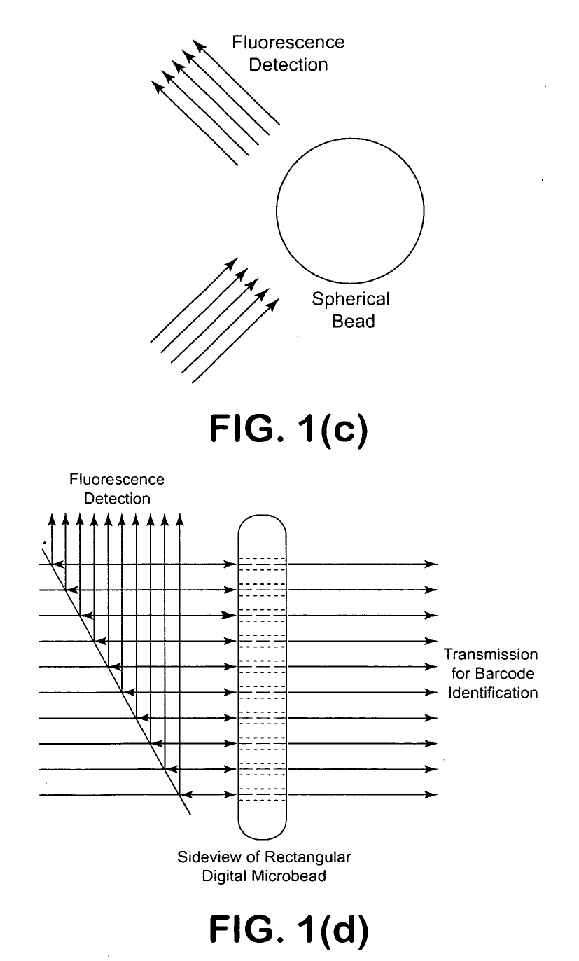

Flow cytometer uses the principle of hydrodynamic focusing by injecting the core flow sample into the center of a coaxial sheath flow. The combined flow is reduced in diameter, forcing the spherical beads or cells into the center of the stream as shown in FIG. 1(a). The flow system is configured in cylindrical tubing. The cross-section view of the tube shows a cylindrical core flow surrounded by a sheath flow that is confined by the cylindrical tube as shown in FIG. 1(b). By this hydrodynamic method, micro particles are positioned in the center of the relative large stream one by one without clogging. As the particle is position in the center for the stream, a laser or other light source is used to irradiate the particles and detect scattering light or fluorescence that is emitted from the particles (FIG. 1(c)).

U.S. Pat. No. 5,736,330 disclosed flow cytometric measurements that are used to classify spherical beads within an exposed bead set to determine the presence of identical or nonidentical sequences within the test sample. The disclosed technology enables the rapid analysis of DNA sequences and detection of point mutations, deletions and/or inversions while also reducing the cost and time for performing genetic assays.

U.S. Pat. No. 7,318,336A disclosed method for controlling one or more parameters of a flow cytometer type measurement system, comprising: monitoring the one or more parameters of the flow cytometer type measurement system during measurements of sample microspheres by the measurement system, wherein one of said parameters is indicative of the velocity of the sample microspheres; and altering the one or more parameters in real time based on said monitoring.

While flow cytometer system is well established, it is designed for monitoring spherical particles, which by nature do not have geometrical orientation (i.e., spherical particles are symmetrical in all directions and orientations). Conventional flow cytometer works well for spherical beads, but it has no ability to control the orientation of non-spherical beads, such as flat pallets or rectangular beads.

The present invention provides a flow system for analyzing rectangular beads.

Rectangular Beads in Microchannel

FIG. 6 illustrates one embodiment of a microfluidic apparatus 31 that is designed to decode the code of the LITAB 11. The microfluidic apparatus includes a micro flow channel 32 defined in a support substrate (e.g., plastic or glass), having a substantially rectangular internal cross section sized and shaped to accommodate a single LITAB 11 in a specific desired orientation (in this case the longitudinal axis of the LITAB 11 is along the axis of the flow channel and the planar surface of the LITAB 11 is generally concentric to the wall of the channel) to flow pass a particular point in the channel. The flow channel may be opened (e.g., an open channel on a support substrate) or covered along the channel. A solution carrying the LITABs flows through the micro flow channel 32, thereby causing the LITABs to flow through the micro channel 32 (e.g., in the laminar flow stream of the solution). The inlet of the micro flow channel 22 is tapered to guide the LITABs to align their longitudinal axis with the channel axis. In other words, the tapered channel inlet geometry is sized and configured to have an internal cross section with a dimension smaller than the dimension of the longitudinal axis of the LITAB 11. The microchannel illustrated in the drawings has a flow cross-section of a substantially rectangular shape instead of spherical shape found in flow cytometer. The LITAB pass through a decoding zone one at a time. A decoding system, positioned with respect to the decoding zone, includes a light source and an optical sensor. In the illustrated embodiment of FIG. 6, the light source may be a diode laser 33, with an objective lens 34, and the optical sensor may be a high-speed photon detector 35 and digital readout electronics 36. The light source 33 and the detector 35 are aligned along an axis orthogonal to the flow path and preferably orthogonal to the surface of the bead 11 on which the digital code is represented. The substrate in which the channel is defined is optically transparent, and if the channel is covered, the cover is also optically transparent. Alternatively, an area light source (e.g., a laser beam having a large enough spot size) may be used to project light to simultaneously cover the entire area of the coded pattern (all the slits) on the LITAB 11, and an area optical sensor such as a CCD sensor may be used to image simultaneously the entire coded pattern as the light transmitted through. This configuration is simple to fabricate and bead's long axis align fairly well with the axis of the flow channel. But the channel size is relatively small, sometime beads can clog together.

Consideration of Rectangular Beads in Flow System

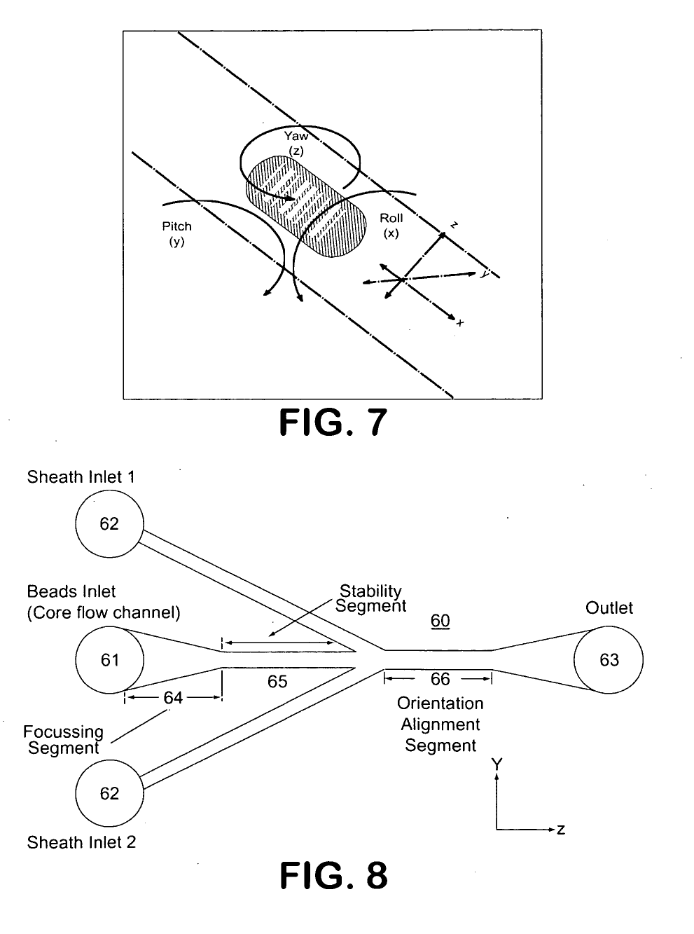

It is noted that rectangular beads are preferably flown in parallel to the channel surface with minimum resistance. However, to achieve optimal results for thousands of beads, considerations should be given to address potential issues of bead clogging, stability, and position centering and geometrical orientation. If beads are clogged in the microfluidic channel, no bead can pass through. When beads are not stable in the flow system, it may cause variation in the optical signal and thus reduce the decoding accuracy. If beads move out of center of the channels the bead may not position properly for light illumination and optical detection. However, bead geometrical orientation is by far the most critical. Rectangular beads can be oriented in three major axes as illustrated in FIG. 7. For example, by reference to FIG. 7, the flow is in x-axis, the perpendicular axis in the plane of the flow is y-axis (i.e., in a direction across the flow channel), and the mutually perpendicular axis is z-axis (i.e., in a direction out of the plane of the flow channel). ‘Roll’, ‘pitch’ and ‘yaw’ are the rotations about x, y and z axes respectively, in reference to the direction of travel (x-direction) of the bead. The angles of roll, pitch, and yaw, theoretically, should be zero in order to keep bead and light beam in optimal condition. In the experiments we notice most of the beads suffer less rotations in pitch for a width of the channel approximately equal to the length of the beads. In addition, it is possible to decode the optical signal even it is not perfect. The tolerance angle is observed to be 10°. These issued can be solved with the following detailed description.

The LITAB microfluidic chip 60 consists of a bead inlet 61 that leads to a main flow channel, two sheath inlets 62 introducing fluid to create a sheath flow in at least a section of the main flow channel, and a channel outlet 63 as shown in FIG. 8. The main flow channel 61 is divided in to three segments, including a focusing segment 64, a stability segment 65, and a geometrical orientation alignment segment 66.
1. At the focusing segment 64, the beads (supported in a solution) entering the channel are focused using geometrical constraints. The focusing segment 64 of the main flow channel is tapered down to a narrower channel section (to the stability segment 65), so that multiple beads are forced to align one by one when they reach the narrower channel section. However, the channel width at the bead inlet 61 end should be larger than both width and length of the bead, to avoid any clogging of the beads at the inlet.
2. The next segment downstream is the stability segment 65 with fixed area cross section which is used to decrease any rotational force. This section provides constant flow and stability to the beads so that the beads flow smoothly in the oriented direction before suffering any fluid dynamic changes at the cross junction of the sheath flow.
3. The final segment downstream is the position centering and orientation alignment section 66 that geometrically positions the beads in the proper orientation by sheath flows from sheath flow inlets 62 for optical decoding and fluorescence detection (optical sensors and complementary incident radiation such as those shown in FIG. 6 are provided, but not shown in FIG. 8). More importantly, the bead surface is oriented 90 degree to the optical light beam with minimal or substantial zero roll, pitch, and yaw angles. The detail is described in the following section.

One-Dimensional Hydrodynamic Focusing for Centering and y Orientation Alignment

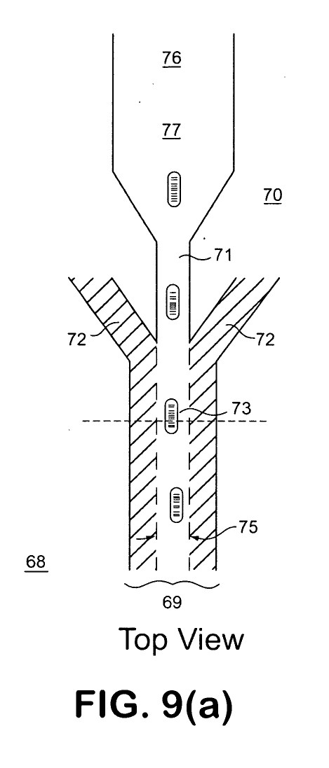

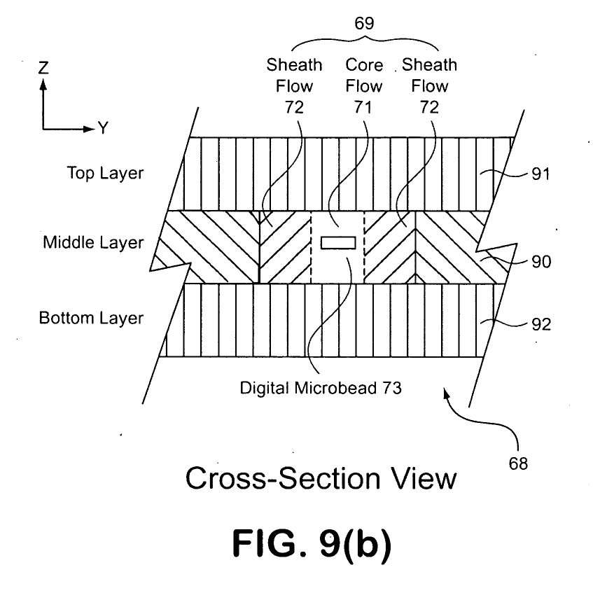

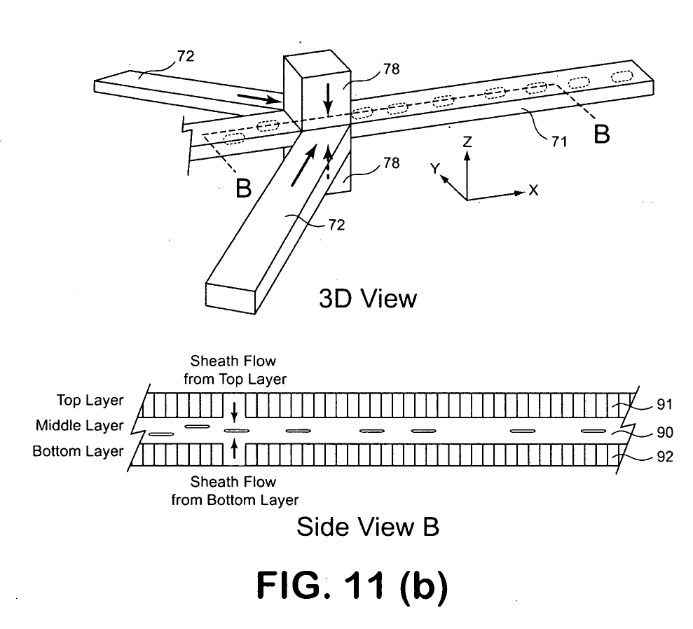

Throughout the disclosure herein, “one-dimensional” and “two-dimensional’ refer to the number of directions of the X-Y-Z coordinate axes. For example, one-dimensional hydrodynamic focusing means providing sheath flows into the main flow channel in a direction of one of the coordinate axes (e.g., sheath flows bound the opposite sides of the core flow having the substantially rectangular flow cross-section, in the direction of the y-axis as shown in FIG. 9(b)). Two-dimensional hydrodynamic focusing means providing sheath flows into the main flow channel in directions of two orthogonal coordinate axes (e.g., sheath flows bound the two pairs of opposite sides of the core flow having the substantially rectangular flow cross-section, in the directions of the y-axis and the z-axis as shown in FIG. 11(c)).

FIG. 9 (a) illustrates another embodiment of a microfluidic apparatus that comprises a sheath flow system 70 to provide steady and stable bead flow through the optical detection area. The sheath system includes one core flow 71, which carries the barcode beads 73, and sheath flows 72, on the side of or about or around the outer periphery of the core flow 71, pulls the core flow 71 into a desired dimension. The beads are mixed in the solution in a container 76, which has a funnel 77 to deliver the beads into the core flow. The sheath flows 72 that carry liquid, such as water is at a significantly higher volume flow rate compared to the core flow (e.g., about twice the volume flow rate of the core flow), but at a lower flow speed due to the larger cross sectional area of the core flow compared that of the sheath flow, can be pushed or pulled by vacuum, gravity, or pressure. The flow speed of the sheath flows should preferably be the same. The liquid of the sheath flows 72 may be same or different as the liquid of the solution supporting the microbeads in the core flow. Due to the laminar flow between the sheath flows and the core flow in the microchannel, the two liquids between the sheath flow and the core flow will not mix appreciably. By adjusting the relative flow rate of core flow 71 and sheath flows 72, the width 75 of the core flow can be optimized for the bead dimension. FIG. 9(b) shows the cross-section view of the rectangular channel with a substantially rectangular core flow sandwiched between the two sheath flows (i.e., a one-dimensional hydrodynamic focusing). The microbead is confined reliably in the center of channel, without wobbling or flipping, in the core flow channel through the detection zone. The flow rate through the micro flow channel is adjustable by using and controlling an external vacuum exhaust line pulling the flow or an external pressure supply pushing the flow. For example, an optimal flow velocity (e.g. 0.1-10 μl/s) is adjusted to secure LITAB integrity during the transportation process.

The microfluidic sheath flow system 70 is embodied in a chip 68. Referring to the embodiment shown in FIG. 9(b), the fluidic chip 68 is assembled with three layers of plastic materials. The middle layer 90 is patterned with the desired microfluidic channel pattern for the sheath flows 72 and core flow 71 shown in FIG. 9(a). FIG. 9(b) is the cross-section view of FIG. 9(a). The thickness of the middle layer 90 is about 50% larger than the bead thickness. The layers are bonded by high pressure heating, for example. The patterned middle layer 90 with the microfluidic rectangular channels is sandwiched between the two layers (i.e., top and bottom layers 91 and 92), the microfluidic channel 69 has a rectangular cross section, which is different from the circular cross section in the regular flow cytometer shown in FIG. 1(b).

Alternatively, instead of a three-layer structure, the fluidic chip may comprise a substrate with a microfluidic channel formed (e.g., etched) thereon, which channel may be covered with a top layer. In other words, in the embodiment of FIG. 9(b), the bottom layer 92 and the middle layer 90 could be an integrated or monolithic structure.

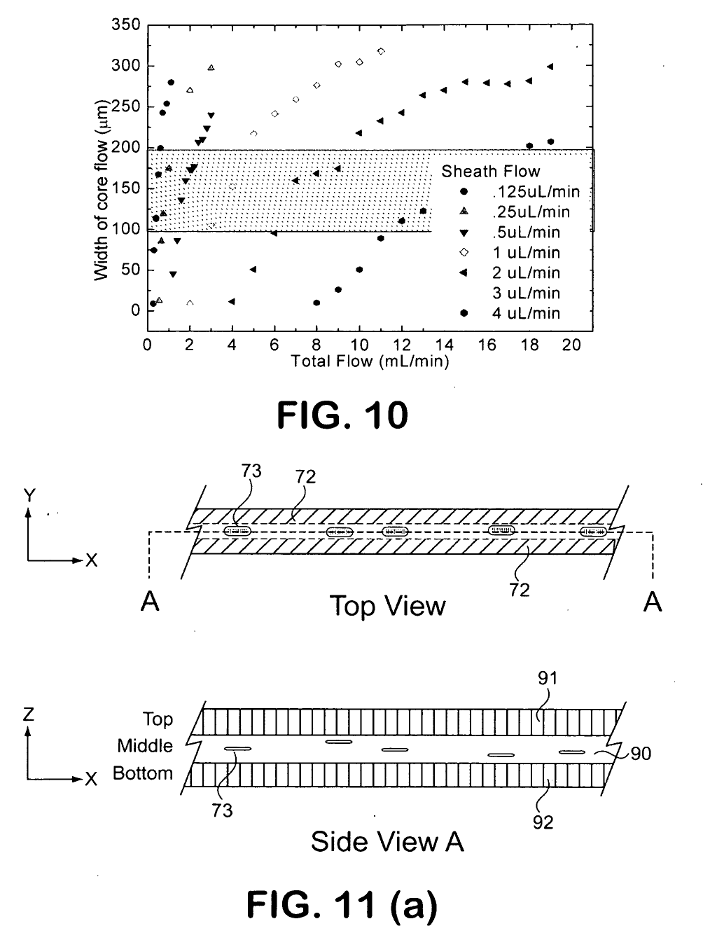

The microfluidics sheath flow device consists of three inlets and an outlet. The core flow with the beads is applied to the middle inlet and sheath flow is applied across the outer inlets. The outlet of the device carries the sum of flow from all the three inlets. The width of the core flow is an important parameter and related to the stability of the beads flowing in the channel. If the width of the core flow is too small, the bead will encounter turbulence caused by the instability in the boundary of core flow and sheath flow. However, if the width of the core flow is too big, the bead will be rotated and oriented freely. FIG. 10 is the experimental results and illustrates the width of the core flow versus the total flow rate (core flow rate+sheath flow rate) at the influence of various sheath flow rates. The width of the core flow is reduced by increasing the magnitude of the sheath flow. The stability of the beads flowing in the channel depends on how the width of the core flow is controlled for a given geometry of the beads. If the length of the beads is 300 μm and the width of the beads is 100 μm, the width of the core flow needs to be more than 100 um. This width corresponds to a tight fit of the beads at the core flow along the width of the beads. Considering that a camera can tolerate an angle (20°) of the orientation of the beads for decoding, the width of the core flow is calculated as 200 μm (=100+sin(20)×300). Hence the operating width of the core flow is between 100 and 200 um as represented in FIG. 10.

Two-Dimensional Hydrodynamic Focusing for x, y, and z Orientation Alignments

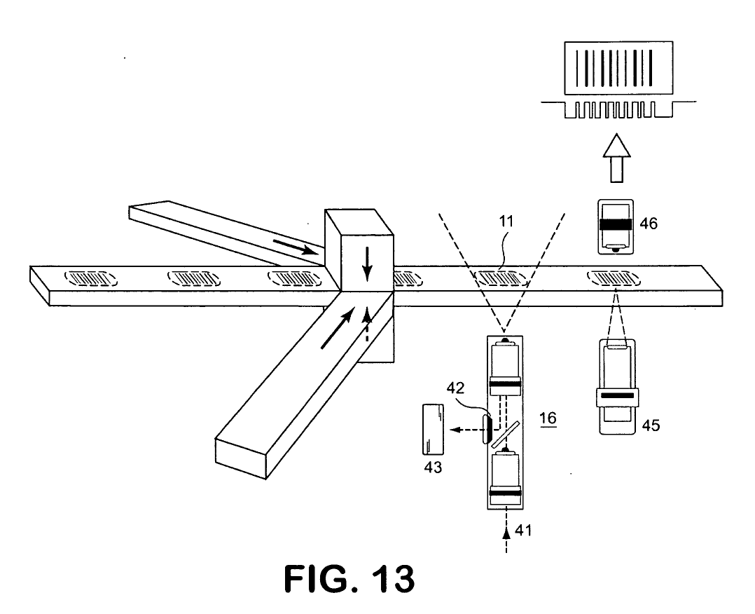

One-dimensional hydrodynamic focusing with two sheath flow inlets is able to confine the core flow or bead in one dimension. FIG. 11 (a) illustrates the top view and longitudinal side sectional view of the microchannel with one-dimensional hydrodynamic focusing. When looking at the channel from the top (i.e., in the z-direction), good alignment of beads in the y-direction is observed. The good alignment is due to the two sheath flows on the sides (i.e., lateral) of the width of the beads. On the other hand, when looking at the channel from the longitudinal side (i.e., looking in the y-direction), the beads travel at different depths. Given the detection optical axis is arranged generally in the z-direction, directing incident light and imaging generally perpendicular to the planar surface of the beads (see, for example, FIG. 13), if the detection optics has a long focus depth, the beads travels at different depth may not cause the problem. But if the depth differences are too big (e.g. >50 um), it becomes impossible to focus the light beam on every bead, thus it can not detect the barcode correctly by imaging. Furthermore, when rectangular beads in the centering position, they can have three major rotations, along x, y and z axes, to change their orientation. Therefore, two-dimensional hydrodynamic focusing with four sheath flows inlets can align the bead orientation in all three axes as shown in FIG. 11(b) and FIG. 11(c). Comparing to the one-dimensional embodiment shown in FIGS. 9(a) and (b), FIG. 11(b) essentially includes two addition inlets for introducing in the z-direction into the flow channel the second dimension of sheath flow 78. FIG. 11 (b) schematically illustrates the structural requirement of horizontal and vertical, two-dimensional sheath flow in the channel in order to align the beads at the center of the channel and also align the bead in proper orientation. This means proper position and orientation can be further optimized with two-dimensional sheath flow in the y-axis as well as z-axis. (In reference to FIG. 8, only the orientation alignment segment of the main flow channel is shown in FIG. 11(b)). The vertical sheath flow in z-axis minimize the rotational effects on x-axis (roll) and y axis (pitch), while the horizontal (or lateral) sheath flow in Y-axis minimize the rotational effect on z-axis (yaw). Therefore, through this method of two-dimensional sheath flow, the beads are well focused and well aligned at the center of the detection zone or cross-section of the channel with proper geometrical orientation. It is noted that the introduction of sheath flow 78 does not need to be at the same location along the main flow channel as the sheath flow 72. For example, the sheath flow 78 may be introduce upstream or downstream of the introduction of the sheath flow 72.

Optimization of Rectangular Beads Flow

To understand the flow behavior of rectangular beads in fluidic channels, it require an optimization of various parameters such as bead's aspect ratio, ratio of widths of channel and bead, radius of corners of beads, ratio of sheath flow and core flow velocity, channel depth and bead thickness. Regulating flow of fluid alone is not sufficient to define the fluid dynamic problem. The rectangular particles are considered as macroparticles since they occupy significant volume and they in turn will affect the flow dynamics of the system. Advanced computer fluidic dynamic models may be applied to simulate and optimize the flow and geometry of the device.

Eulerian-Lagrangian or discrete particle approach (Kaneko et al., 1999 and Kobayashi et al., 2000) and Eulerian-Eulerian or two fluid approach (Pain et al., 2001 and Patil et al., 2005b) have been used to model particles flowing in a channel. In the Eulerian-Lagrangian model, the Newtonian equations of motion effects of particle collisions and forces acting on the particles are included for each individual particle. Eulerian-Lagrangian models involve intensive computations and are normally limited to a relatively small numbers of particles (Ranade, 2002). On the other hand, in Eulerian-Eulerian approach, both the phases of the fluid and the particles are considered as an interpenetrating continuum. However, this approach is not designed for studying rectangular beads flowing in a channel since these beads occupy a definite volume and substantially affect the surrounding flow. Simulating the flow rectangular beads can be carried out to a better accuracy using Surface Marker approach. In this approach an individual particle is tracked using a center of mass location and a number of marker points. Porosity model clocks off the region occupied by the bead to the fluid and six-DOF model calculates the force balance on the bead and the fluid. The accuracy of this approach depends on the computational grids used in the simulation and this approach is suitable for these larger size beads. The Navier-Stokes equations for incompressible laminar flow is written using fluid volume fraction, α and fluidic stresses τ

$$∇ \cdot α {v}^{->} = 0$$

$$\frac{\partial α ρ {v}^{->}}{\partial t} + {v}^{->} \cdot ∇ α ρ {v}^{->} = - α ∇ P + ∇ \cdot α τ + α ρ {g}^{->}$$

Where ρ, v, P, g are density, velocity, pressure and gravity respectively. The hydrodynamic force on a bead described by N number of marker point is calculated by integrating normal vectors, n of pressure and stress tensor with the surface area, ΔA associated with each market points, k.

$${F}^{->} = {\sum }_{k = 1}^{N} ( - {p}_{k} {{n}^{->}}_{k} + {τ}_{k} \cdot {{n}^{->}}_{k} ) ∇ {A}_{k}$$

The dimension of the rectangular beads is compared to the dimensions of the channel and so the beads cannot be treated as point particles. Moreover, the beads affect the flow of surrounding fluid substantially and can collide with the wall or any neighboring beads. In order to track these rectangular beads flowing in a microfluidic channel, we adapted trajectory based Eulerian-Lagrangian methods. In this method the fluid phase is solved in Eulerian frame of reference and the particles are tracked as discrete entities in a Lagrangian frame of reference

Examplary Parameters for Hydrodynamic Focusing

| Parameters | Parameters |
|---|---|
| Bead size | 100 × 30 × 5 μm to |
| | 300 × 100 × 20 μm |
| Barcode | 1,024 (10 digits) |
| Bead material density | ~1.28 g/cm3 |
| Channel dimension (cross-section) | 300 × 50 μm |
| Sheath volume flow rate | 2-10 ml/min for each |
| | sheath flow |
| Bead solution (core flow) volume flow rate | 1.0-7.0 ml/min |
| Sample volume after dilution in bead solution | 0.5-5.0 ml |
| Bead velocity (core flow speed) | 0.1-2.0 m/sec |
| Number of beads for each sample | 5,000-100,000 beads |
| Rapid throughput per sample or per well | 30-60 seconds |
| Total time for 96-well plate | 40-100 minutes |
| Light source for fluorescence (PE, Cy3) & | 530 nm (depends on |
| decoding | fluorophores) |

Optical Decoding of Rectangular Beads

The optical barcodes can be detected by two methods: barcode image detection and time-domain detection. In both cases, it is preferred that the light beam (and/or optical axis of the detection system) be directed in a direction perpendicular to the bead surface. (However, other angles may be acceptable as long as the incident light is able to sufficiently pass through the beads in the illustrated embodiment in FIG. 13, for example.) In the barcode image detection method, an array of CCD, such as 1×512 pixels, is aligned in parallel to the barcode array. When the LITAB bead passes through the detection zone, the high contrast transmitted barcode pattern is imaged on the CCD array as shown in FIG. 2(c). The CCD array has sufficient pixel to resolve the smallest barcode pattern with a zoom lens (20×-40×) to enlarge the barcode pattern. It is possible to take several frames of bead image as bead flow through. All digits of the barcode are simultaneously detected by the array. Barcode time-domain method, on the contrary, only requires one pixel of a CCD, or a photodiode or a photomultipler tube with a pinhole to define the spatial resolution. Time-domain method requires having a high speed data acquisition board, >1 MHz, in order to resolve the high speed of the barcode passing through the detector. The system is able to distinguish between the “0” or “1” barcode based on the time scale. Decoding of such signals to binary number is not trivial to address different barcodes. In the case of beads detected with line camera, the beads are captured as the beads enter the viewing area in the microscope. The beads are captured by 10-30 number of frames depending on the velocity of the beads and the frame rate of the camera. The first and last frame number is detected and the a few mid frames are extracted. The barcode signals are integrated with spatial corrections for adjacent beads. The reinforced signal is dissembled using the ratios of number pixels and widths. The MSB, 10 digit number and LSB are extracted and the digital number is formed. The digital readout electronics (MHz-GHz) may control a line scan camera using a microcontroller or digital signal processor, which collects data from the optical sensor when triggered and gated. The digital processor reads the stream of 1's and 0's that represent light intensities at intervals of 100 μs, for example, and perform rapid pattern recognition to determine the slit width sequence, based on the spacing between 1's and 0's. The LITABs 11 are configured to move at a speed of about 10-30 mm/sec, so that readout only requires about 7 milliseconds per LITAB. Data-processing steps may be implemented by algorithms using digital signal processing software, including a c-code that quickly and efficiently processes each pattern. Details of such software are not discussed herein, since it can be developed by one skill in the art, given the functions and processes discussed herein.

LITAB Fluorescence Detection and Bioassay

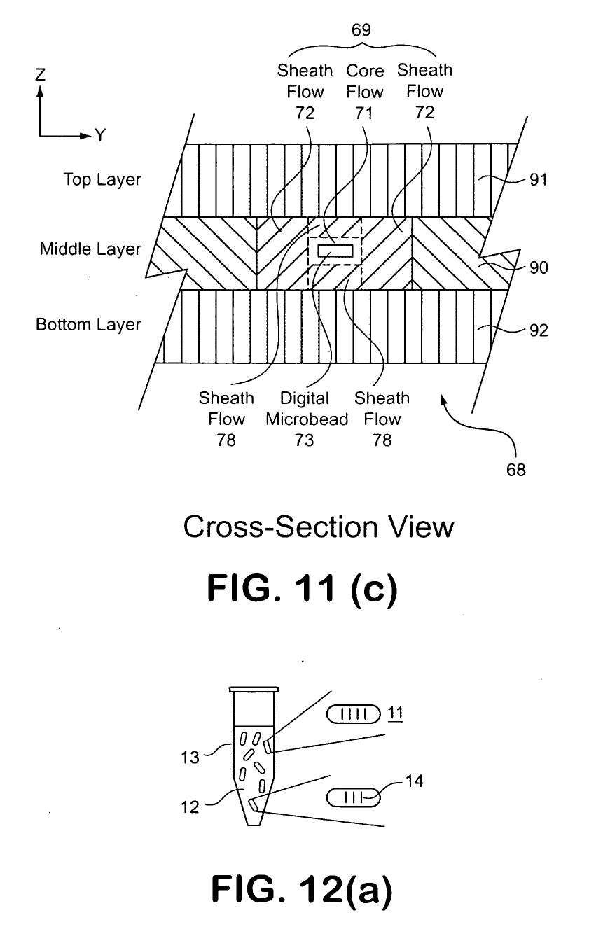

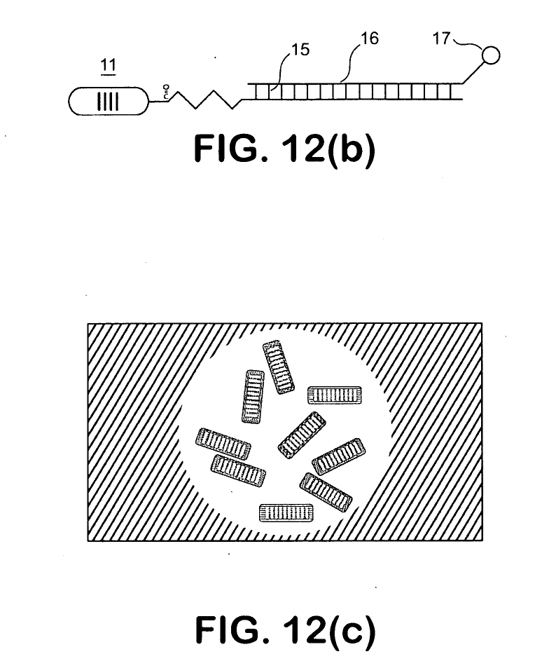

FIG. 12 illustrates an embodiment for preparing LITAB for bioassays. As shown in FIG. 12(a), the LITABs 11 allow multiplexed homogeneous bioassays on micro-volume samples. A mixture of LITABs 11 corresponding to different codes 14 are introduced into a small volume of biological sample 12 in a tube 13. The LITABs can be optically decoded easily and rapidly thereafter. In one embodiment, FIG. 12(b) shows one LITAB 11 functionalizing with nucleic acid probe 15 for target hybridization 16 and fluorescence detection 17. Several materials are available for bead immobilization. In one embodiment, the LITAB may be coated with a covalent DNA-binding agent used in microarray. The probe beads were subsequently hybridized in solution to a complementary oligo target which carried a covalently bound fluorophore at its 5′ end. FIG. 12(c) is an image of LITABs (size 200 μm×100 μm×20 μm) captured with a microscope.

In a further aspect of the present invention, a bioanalysis system is configured and structured for conducting bioanalysis using the coded bead of the present invention. The microfluidic system comprises the microfluidic apparatus to facilitate high throughput homogeneous or heterogeneous analysis. The detection zone of the microfluidic apparatus further includes a reaction detector (e.g., a fluorescence detector, an absorption detector, a chemiluminescent detector, etc.) for detecting the result of reactions taken place on the coded beads. In one embodiment, the assay of the microfluidic system is configured and adapted for high-throughput analysis for immunoassay, gene expression, Single Nucleotide Polymorphism (SNP) diagnostics, DNA-based tissue typing, or transcriptional profiling.

When the identifiable LITAB is immobilized with the capture probe, an optical label can be used for detection of positive or negative reaction. The label can be fluorescence label, chemiluminescence label, or absorption label. In one embodiment, the reaction detection system 19 may include a fluorescence detector that measures fluorescence signal from the label material on the bead. FIG. 13 shows a mixture of LITABs 11 that is introduced into the micro flow channels with two-dimensional sheath flows (e.g., the sheath flow microchannels shown in FIG. 11(b)) for both barcode identification and fluorescence detection. When a positive fluorescence signal is detected, it indicates a positive reaction. The optical detection system comprises a light source 41, optical filter 42 and detector 43. Light diffuser (not shown) can improve the uniformity of light illumination. The choice of light source depends on the fluorophore. For example, red diode laser (665 nm), and compact Argon Laser (488 nm) or Helium laser, can be the light source for Picogreen and Cy 5.5 fluorophore. Optical filter 42 removes the reflected excitation light that is mixed in the fluorescence (e.g., Picogreen: 525 nm filter and Cy5.5: 694 nm filter). Phycoerythrin can be excited with 530 nm green light and detected the fluorescence at 575 nm. Cy 3 and Cy5 are commonly used fluorescence dyes; they can be excited with green light (530 nm) and red light (635 nm), respectively. The fluorescence intensity is commonly measured with a photomultiplier tube as the detector 43. The barcode identification is performed with a white light source 45 and CCD as a detector 46 for rapid barcode detection.

Some aspects of the invention relate to the LITAB technology and its high-throughput screening application in immunoassay, antigen, antibody, pathogens, gene expression, nucleic acid hybridization, cancer diagnostics, single nucleotide polymorphisms (SNPs), and etc. Bioassays based on LITAB can be used extensively throughout the life sciences industry, drug discovery, clinical laboratory tests, and pharmacogenomics. For example, the multiplexed bioassays can be used to measure the affinity between a chemical compound and a disease target for drug discovery and development, assist physicians in prescribing the appropriate drug therapy to match the patient's unique genetic makeup, and detect genetic variations.

Some aspects of the invention relate to the LITAB is for cost-efficient automated human leukocyte antigen (HLA) typing (the HLA-TYPER system). The HLA-TYPER is designed to capture the amplified alleles onto digitally bar-coded beads by hybridization, and (iii) to detect the amplified alleles (i.e. identification of the micro-pallets' bar-codes and the quantitation of the fluorescent signal emitted by the excited beads. The combination of the highly multiplexed amplification technology with the bead-based and automated microfluidic detection of the HLA-alleles offers the two following advantages over current methods for high-resolution HLA typing: the system is (i) accurate and (ii) cost-effective through reduction in labor, reagent and consumable costs. Currently there are ˜3000 primer pairs for initial low resolution and ˜1500 primer pairs necessary to perform subsequent high-resolution HLA typing. The platform is amenable to scale and could allow patient DNA to be screened for hundreds of different ambiguous alleles with high sensitivity and specificity at once without the necessity of tedious rounds of allele screening to increase resolution.

Some aspects of the invention relate to the LITAB is for the identification and enrichment of segments of circulating DNA in human blood that harbor mutations associated with cancer. The LITAB enriches for specific DNA segments by hybridization to complementary capture sequences on bar coded beads that are subsequently flow-sorted into different microwells. The identification of specific mutant alleles in these sorted fragments is accomplished via PCR-based screens conducted with the enriched DNA in each microwell. The method minimizes user errors and reduces labor, reagent and consumable costs. The platform is amenable to scale up and could allow thousands of different DNA segments to be screened for specific mutations with high sensitivity and specificity. The advantage of the LITAB system over existing technology is its sorting potential that enables for individual selection and enrichment of thousands of small fragments of mutant DNA from a highly complex genomic DNA suspension in a parallel fashion. This technology will enable circulating DNA in body fluids to become a powerful indicator in clinical cancer diagnostics.

Some aspects of the invention relate to the LITAB to identify genes whose SNP genotypes or haplotypes correlate with different individual drug responses, other metabolic processes or disease susceptibility. Thus the ability to quickly and accurately determine genotypes for medically relevant regions will be both critical to understanding the effects of an individual's genetic profile on these processes, and for the development of predictive, preventative and personalized medicine. The LITAB technology for use in pharmacogenetic SNP genotyping assays for medically relevant genes will allow high-throughput molecular diagnostic profiling of individuals. The specific hybridization of DNA probes to capture probe sequences immobilized on LITABs was evaluated using oligo sequences from the published cDNA sequence of the breast cancer 1 gene, BRCA1. Target 1 (WILDTYPE) contains the wildtype (normal) sequence. Target 2 (SNP) contains a mutant sequence with the single nucleotide polymorphism (SNP) T→C substituted at position 331. This mutation results in the amino acid substitution of an arginine residue in place of the normal cysteine residue in codon 64 of the BRCA1 protein. Each 30 bp capture probe was attached to a differently coded bead. The two bead types were co-hybridized overnight at 50° C. in solution (2×SSC, 0.1% SDS, poly dA) with a Cy5 5′ labeled probe containing the complementary sequence to the Target 2 (SNP) mutant sequence. Following post-hybridization washes to remove the unbound probe the beads were immobilized on a glass slide and confocal fluorescence images were recorded. Significantly higher signals (˜10×) were observed for the SNP bead over the WILDTYPE bead indicating that the SNP probe hybridization was specific to its complementary capture probe. Control staining of both bead types with propidium iodide confirmed that that the distribution of the capture probes was similar on both beads. This confirmed that the difference in Cy5 signal was due to specific hybridization of the labeled probe to the correct target. Similar results were obtained using the reverse system, where the labeled probe consisted of a DNA sequence complementary to the WILDTYPE capture probe sequence.

While the invention has been described with respect to the described embodiments in accordance therewith, it will be apparent to those skilled in the art that various modifications and improvements may be made without departing from the scope and spirit of the invention. Accordingly, it is to be understood that the invention is not to be limited by the specific illustrated embodiments, but only by the scope of the appended claims.

1. A microfluidic apparatus for analyzing rectangular beads with different dimensions along at least two orthogonal axes, comprising:
a main flow channel sized and configured to allow passage of the rectangular beads, wherein the rectangular beads are supported by a first solution; and
at least one sheath flow channel in flow communication with the main flow channel, providing a flow of a second solution into the main channel to create a sheath flow in relation to a core flow of the first solution in a sheath flow section of the main flow channel, wherein the sheath flow maintains the rectangular beads in a specific orientation with respect to the main flow channel as the rectangular beads flow through said sheath flow section.

2. A microfluidic apparatus as in claim 1, wherein the main flow channel comprises:
a focusing segment that aligns the rectangular beads using geometrical constraints;
a stability segment downstream of the focusing segment, wherein the stability segment provides flow stability to the rectangular beads for the core flow; and
an orientation alignment segment downstream of the stability segment, defining said sheath flow section in the main flow channel for the sheath flow.

3. A microfluidic apparatus as in claim 2, further comprising at least one sheath inlet introducing the second solution into the sheath flow channel, and a bead inlet introducing rectangular beads into the focusing segment.

4. A microfluidic apparatus as in claim 1, wherein the main flow channel has a substantially rectangular cross-section, and wherein at least two sheath flow channels are provided to introduce the second solution into the sheath flow section to create two sheath flows on two opposite sides of the core flow.

5. A microfluidic apparatus as in claim 4, wherein said two sheath flows provide lateral alignment of each rectangular bead, and two further sheath flow channels are provided to introduce the second solution into the sheath flow section to create two further sheath flows on two other opposite sides of the core flow orthogonal to the two opposite sides, to provide vertical alignment of each rectangular bead.

6. A microfluidic apparatus as in claim 5, wherein the two sheath flows and two further sheath flows maintain yaw, pitch and roll orientations of the rectangular beads.

7. A microfluidic apparatus as in claim 4, wherein the sheath flows flow at lower flow speed compared to that of the core flow.

8. A microfluidic apparatus as in claim 1, wherein volume flow rate of the sheath flows is higher than that of the core flow, and wherein relative flow rate of the core flow and the sheath flow is controlled to maintain orientation of the rectangular beads.

9. A microfluidic apparatus as in claim 1, further comprising a detecting system provided along the sheath flow section for detecting the rectangular beads.

10. A microfluidic apparatus as in claim 9, wherein the rectangular beads are provided with digital codes, and wherein the rectangular beads are maintained by the sheath flow in the specific orientation pass the detecting system for decoding the digitally codes.

11. A microfluidic apparatus as in claim 10, wherein the rectangular beads are digitally coded with bar codes, and wherein optical axis of the detection system is substantially perpendicular to plane of the rectangular beads on which digital codes are provided.

12. A method of for analyzing rectangular beads with different dimensions along at least two orthogonal axes, comprising:
providing a main flow channel sized and configured to allow passage of the rectangular beads;
introducing a first solution supporting the rectangular beads;
providing at least one sheath flow channel in flow communication with the main flow channel;
providing a flow of a second solution into the main channel to create a sheath flow in relation to a core flow of the first solution in a sheath flow section of the main flow channel, wherein the sheath flow maintains the rectangular beads in a specific orientation with respect to the main flow channel as the rectangular beads flow through said sheath flow section.

13. A method as in claim 12, wherein the main flow channel comprises:
a focusing segment that aligns the rectangular beads using geometrical constraints;
a stability segment downstream of the focusing segment, wherein the stability segment provides flow stability to the rectangular beads for the core flow; and
an orientation alignment segment downstream of the stability segment, defining said sheath flow section in the main flow channel for the sheath flow.

14. A method as in claim 13, further comprising providing at least one sheath inlet introducing the second solution into the sheath flow channel, and a bead inlet introducing beads into the focusing segment.

15. A method as in claim 12, wherein at least two sheath flow channels are provided to introduce the second solution into the sheath flow section to create two sheath flows on two opposite sides of the core flow.

16. A method as in claim 15, wherein the main flow channel has a substantially rectangular cross-section, and wherein said two sheath flows provide lateral alignment of each rectangular bead, and wherein the method further comprising providing the second solution into the sheath flow section to create two further sheath flows on two other sides of the core flow orthogonal to the two opposite sides, to provide vertical alignment of each rectangular bead.

17. A microfluidic apparatus as in claim 16, wherein the two sheath flows and two further sheath flows maintain yaw, pitch and roll orientations of the rectangular beads.

18. A method as in claim 12, wherein volume flow rate of the sheath flows is higher than that of the core flow, and wherein relative flow rate of the core flow and the sheath flow is controlled to maintain orientation of the rectangular beads.

19. A method as in claim 12, further comprising detecting the rectangular beads using a detecting system provided along the sheath flow section.

20. A method in claim 19, wherein the rectangular beads are provided with digital codes, and wherein the rectangular beads are maintained by the sheath flow in the specific orientation pass the detecting system for decoding the digitally codes, and wherein optical axis of the detection system is substantially perpendicular to plane of the rectangular beads on which digital codes are provided.
